(19) United States
(12) Patent Application Publication
(10) Pub. No.: US 2022/0379909 A1
(43) Pub. Date: Dec. 1, 2022

(54) Controlling And Warning System Based On Traffic Conditions Feedback And Method Thereof

(71) Applicants: Inventec (Pudong) Technology Corporation, Shanghai (CN); Inventec Corporation, Taipei City (TW)

(72) Inventors: Po-Hsiang Wu, Taipei City (TW); Chaucer Chiu, Taipei City (TW); Jiun-Kuej Jung, Taipei City (TW); Yu-Chang Chuang, Taipei City (TW)

(21) Appl. No.: 17/477,084

(22) Filed: Sep. 16, 2021

(30) Foreign Application Priority Data
Jun. 1, 2021 (CN) 202110607209.4

(51) Int. Cl. B60W 50/16; B60Q 1/44; G06K 9/00; G06N 3/04; B60W 40/04; B60W 10/18

(52) U.S. Cl. CPC B60W 50/16; B60Q 1/44; G06K 9/00825; G06K 9/00744; G06N 3/04; B60W 40/04; B60W 10/18; B60W 2050/143

(57) ABSTRACT

A controlling and warning system based on traffic conditions feedback and a method thereof are disclosed. In the controlling and warning system, a camera disposed on a rear of a vehicle body is configured to generate and transmit a rear video to a controlling host, and the controlling host identifies a vehicle object in the rear video and calculates a separation distance between the vehicle object and the vehicle body; the vehicle object is inputted into a large-sized vehicle recognition model which is built based on artificial intelligence neural network and trained completely, to recognize whether the vehicle object is a large-sized vehicle; when the vehicle object is recognized as the large-sized vehicle and the separation distance reaches to a safe distance, a warning signal is generated. Therefore, the technical effect of improving the warning immediacy of an approaching large vehicle can be achieved.

### CROSS-REFERENCE TO RELATED APPLICATION

This application claims the benefit of Chinese Application Serial No. 202110607209.4, filed Jun. 1, 2021, which is hereby incorporated herein by reference in its entirety.

### BACKGROUND OF THE INVENTION

### 1. Field of the Invention

The present invention relates to a warning system and a method thereof, and more particularly to a controlling and warning system based on traffic conditions feedback and a method thereof.

### 2. Description of the Related Art

In recent years, with the widespread and vigorous development of the vehicle industry, bicycles, motorcycles and automobiles have sprung up, but these vehicles have also brought many problems. Among these problems, driving safety is the most important.

Regarding to driving safety, the conventional bicycles, motorcycles or automobiles generally lack the warning and protection schemes based on the surrounding traffic conditions, and it may lead to high driving risks and the increase of traffic accidents every year. Blind spot is often the main cause of traffic accidents, especially for the driver of a large-sized vehicle; the large-sized vehicle has relatively more blind spots, so it is more likely to cause accidents due to blind spots. Therefore, for the drivers of bicycles, motorcycles or automobiles, how to effectively prevent traffic accidents with a large-sized vehicle is an urgent problem that needs to be solved.

In view of this problem, some manufacturers have proposed a rear-view mirror combined with a displayer to display blind spots, to reduce the blind spot of the line of sight, so as to prevent from traffic accident due to the blind spot of the line of sight. However, the above-mentioned manner requires the driver to continue to pay attention to watch the displayer, and when the vehicle has more blind spots that need to be watched out, the above-mentioned manner causes the driver to be distracted, and it is likely to cause a traffic accident. Therefore, for the drivers of bicycles, motorcycles or automobiles, the above-mentioned conventional manner is not as useful as the manner of immediately warning the driver about the approaching large-sized vehicle to make the driver improve concentration and vigilance.

According to the above-mentioned contents, the conventional technology has the problem of failing to immediately warning that a large-sized vehicle is approaching, and what is needed is to develop an improved technical solution to solve the problem.

### SUMMARY OF THE INVENTION

An objective of the present invention is to provide a controlling and warning system based on traffic conditions feedback and a method thereof, so as to solve the convention technology problems.

In order to achieve the objective, the present invention discloses a controlling and warning system based on traffic conditions feedback, the system includes a camera and a controlling host. The camera is disposed on a rear of a vehicle body, and when the camera is enabled, the camera continuously shoots video to generate and transmit a rear video. The controlling host is connected to the camera through network, and configured to receive the rear video. The controlling host includes a storage module, an identifying module and a warning module. The storage module is configured to pre-store a large-sized vehicle recognition model which is built based on neural network and trained completely. The identifying module is configured to perform image identification process on the received rear video, to identify at least one vehicle object in the rear video and calculate a separation distance between the vehicle object and the vehicle body. The warning module is connected to the identifying module and the storage module, and configured to input the vehicle object into the large-sized vehicle recognition model. When the large-sized vehicle recognition model recognizes the vehicle object as a large-sized vehicle and the separation distance reaches to a safe distance, the warning module generates a warning signal.

Furthermore, the present invention discloses a controlling and warning method based on traffic conditions feedback, and the method includes steps of: providing a controlling host, and a camera disposed on a rear of a vehicle body, wherein the camera is connected to the controlling host through network, and the controlling host pre-stores a large-sized vehicle recognition model which is built based on neural network and trained completely; when the camera is enabled, using the camera continuously shoot environment behind the vehicle body, so as to generate and transmit a rear video to the controlling host; using the controlling host to perform image identification process on the rear video, to identify at least one vehicle object in the rear video and calculate a separation distance between the vehicle object and the vehicle body; in the controlling host, inputting the vehicle object into the large-sized vehicle recognition model, and generating a warning signal when the large-sized vehicle recognition model recognizes the vehicle object as a large-sized vehicle and the separation distance reaches to a safe distance.

According to the system and method of the present invention, the difference between the present invention and the conventional technology is that, in the present invention, the camera disposed on the rear of the vehicle body can generate and transmit the rear video to the controlling host, and the controlling host identifies the vehicle object in the rear video and calculates the separation distance between the vehicle object and the vehicle body, and the vehicle object is inputted into the large-sized vehicle recognition model which is built based on artificial intelligence neural network and trained completely, to recognize whether the vehicle object is the large-sized vehicle, and when the vehicle object is recognized as the large-sized vehicle and the separation distance reaches to the safe distance, the warning signal is generated.

The above-mentioned technical solution of the present invention can achieve the technical effect of improving warning immediacy for the approaching large-sized vehicle.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a controlling and warning system based on traffic conditions feedback, according to the present invention.

FIG. 2A to 2C are flowcharts of a controlling and warning method based on traffic conditions feedback, according to the present invention.

FIG. 3 is a schematic diagram of application of shooting a rear video to perform controlling and warning operations during vehicle traveling, according to the present invention.

FIG. 4 is a schematic diagram of application of transmitting a first control signal and a second control signal to a mobile device, for warning, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The environment where the present invention is applied is explained before the description of the controlling and warning system based on traffic conditions feedback and a method of the present invention. The present invention can be applied in the environment of internet of vehicles (IoV), the camera disposed on the rear of a vehicle body can transmit data (such as a rear video) through the network, and the network can include at least one of the local area network and the internet.

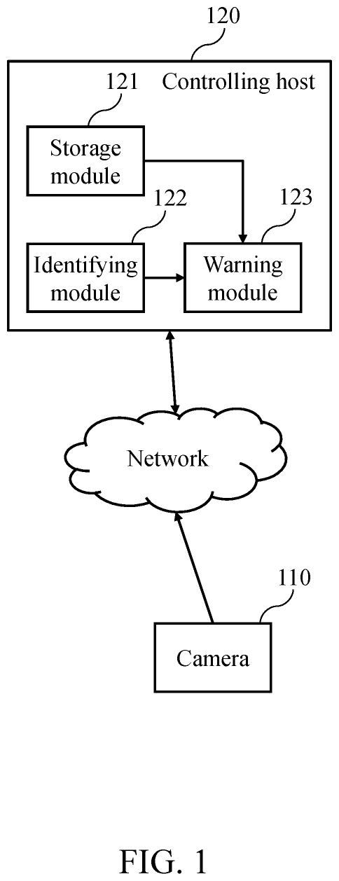

The controlling and warning system based on traffic conditions feedback and a method of the present invention will hereinafter be described in more detail with reference to the accompanying drawings. Please refer to FIG. 1, which is a system block diagram of a controlling and warning system based on traffic conditions feedback, according to the present invention. The system includes a camera 110 and a controlling host 120, the camera 110 is disposed on the rear of the vehicle body, and when the camera is enabled, the camera continuously shoot video, so as to generate and transmit a rear video. In actual implementation, the camera 110 can include at least one of the charge-coupled device (CCD) and complementary metal-oxide-semiconductor (CMOS). Furthermore, the camera 110 can transmit the rear video through a wired transmission manner or a wireless transmission manner. For example, the wired transmission can be implemented by copper conductive line, coaxial cable, or dual twisted wire; the wireless transmission manner can be implemented by Wi-Fi, ZigBee, Constrained Application Protocol (CoAP), message queuing telemetry transport (MQTT) or other similar wireless transmission technology.

The controlling host 120 is connected to the camera 110 through the network, and configured to receive the rear video. The controlling host 120 can include a storage module 121, an identifying module 122, and a warning module 123. The storage module 121 is configured to pre-store a large-sized vehicle recognition model which is built based on a neural network and trained completely. In an embodiment, the large-sized vehicle recognition model is a machine learning model which is trained completely, and the large-sized vehicle recognition model can be implemented by deep learning technologies, such as deep neural network (DNN), convolutional neural network (CNN), recurrent neural network (RNN) or sequential approximation neural network.

The identifying module 122 performs the image identification process on the rear video to identify a vehicle object in the rear video, and calculate a separation distance between the vehicle object and the vehicle body. In actual implementation, the separation distance between the vehicle object and the vehicle body can be calculated based on a rectangular size of the vehicle object in the image, for example, a larger rectangular area means a short separation distance, and a smaller rectangular area means a long separation distance.

The warning module 123 is connected to the identifying module 122 and the storage module 121, and configured to input the vehicle object into the large-sized vehicle recognition model, and when the large-sized vehicle recognition model recognizes the vehicle object as a large-sized vehicle, when the separation distance reaches to the safe distance, the warning module 123 generates a warning signal. In actual implementation, when the warning signal is generated, the warning module 123 outputs a warning message and calculates a difference value between the separation distance and the safe distance, when the difference value reaches to a first threshold value, the warning module 123 generates a first control signal to trigger the loudspeaker device to make the warning sound, when the difference value is equal to a second threshold value, the warning module 123 generates a second control signal to trigger a speaker disposed on the vehicle body. The controlling host 120 can transmit the generated first control signal and second control signal to a mobile device, the mobile device immediately warns by using at least one of manners of outputting text, vibrating and making sound based on the first control signal and the second control signal. Furthermore, when the second control signal is generated and the vehicle object is not located in the area behind the vehicle body, the controlling host 120 can drive a brake controller disposed in the vehicle body to immediately reduce the speed of the vehicle body. Furthermore, in another embodiment, when the second control signal is generated, the controlling host 120 can trigger an auxiliary brake light disposed on the vehicle body and make the auxiliary brake light keep on until the separation distance is greater than the safe distance. In practical application, the controlling host 120 can be a smartphone, a tablet computer, a desktop computer, a notebook computer, an in-vehicle computer, a server or the like, and the controlling host 120 can trigger the loudspeaker device and the speaker device through an application programming interface (API).

It is to be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

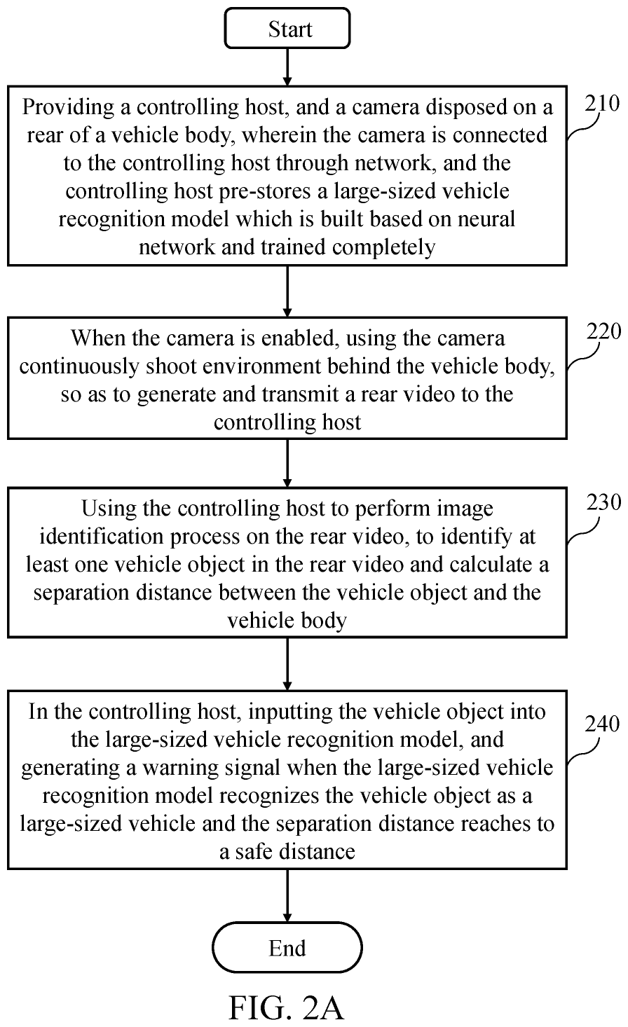

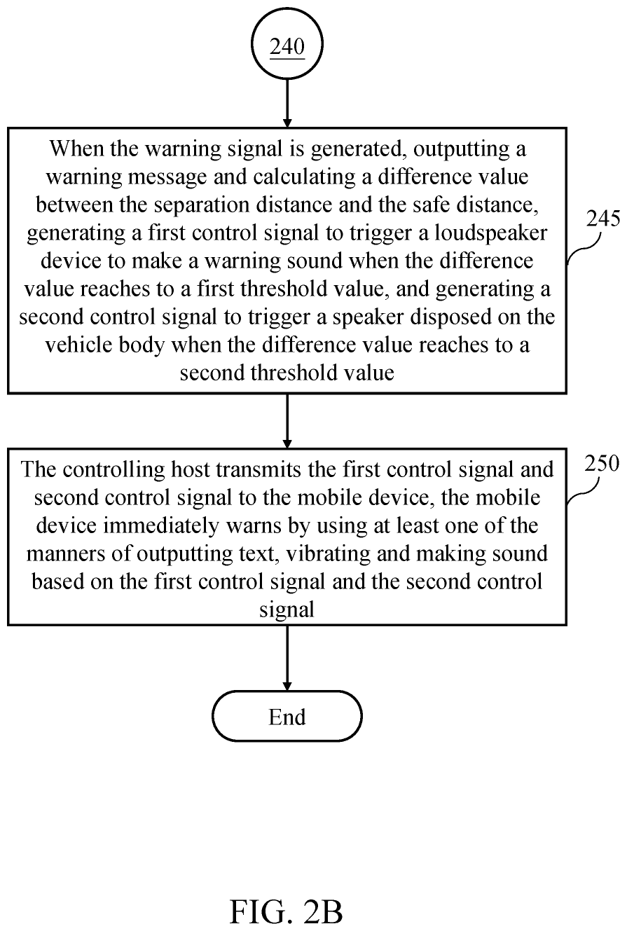

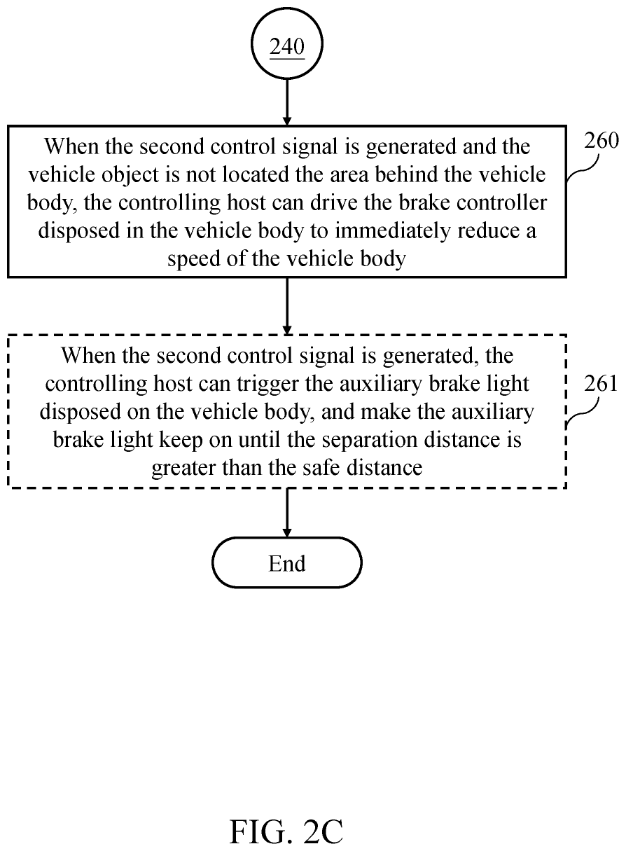

Please refer to FIG. 2A to 2C, which are flowcharts of a controlling and warning method based on traffic conditions feedback, according to the present invention. The controlling and warning method includes the following steps. In a step 210, the controlling host 120, and the camera 110 disposed on the rear of a vehicle body are provided, the camera 110 is connected to the controlling host 120 through the network, and the controlling host 120 pre-stores the large-sized vehicle recognition model which is built based on neural network and trained completely. In a step 220, when the camera is enabled, the camera 110 continuously shoots the environment behind the vehicle body to generate the rear video, and transmits the rear video to the controlling host 120. In a step 230, the controlling host 120 performs the image identification process on the rear video to identify the vehicle object in the rear video, and calculates the separation distance between the vehicle object and the vehicle body. In a step 240, the controlling host 120 inputs the vehicle object into the large-sized vehicle recognition model, and generating a warning signal when the large-sized vehicle recognition model recognizes the vehicle object as a large-sized vehicle and the separation distance reaches to a safe distance. Through aforementioned steps, the camera 110 disposed on the rear of the vehicle body can generate and transmit the rear video to the controlling host 120, so that the controlling host 120 can identify the vehicle object in the rear video, calculate the separation distance between the vehicle object and the vehicle body, and input the vehicle object into the large-sized vehicle recognition model which is built based on neural network and trained completely, to recognize whether the vehicle body is the large-sized vehicle, and when the vehicle object is recognized as the large-sized vehicle and the separation distance reaches the safe distance, the controlling host 120 generates the warning signal.

Furthermore, in an embodiment, a step 250 can be performed after the step 240; as shown in FIG. 2B, in the step 245, when the warning signal is generated, outputting a warning message and calculating a difference value between the separation distance and the safe distance, generating a first control signal to trigger a loudspeaker device to make a warning sound when the difference value reaches to a first threshold value, and generating a second control signal to trigger a speaker disposed on the vehicle body when the difference value reaches to a second threshold value; in the step 250, the controlling host 120 transmits the generated first control signal and second control signal to the mobile device, the mobile device immediately warns by using at least one of the manners of outputting text, vibrating and making sound based on the first control signal and the second control signal. Furthermore, as shown in FIG. 2C, steps 260 and 261 in a step 260 can be performed after the step 240; in the step 260, when the second control signal is generated and the vehicle object is not located the area behind the vehicle body, the controlling host can drive the brake controller disposed in the vehicle body to immediately reduce a speed of the vehicle body; in a step 261, when the second control signal is generated, the controlling host can trigger the auxiliary brake light disposed on the vehicle body, and make the auxiliary brake light keep on until the separation distance is greater than the safe distance.

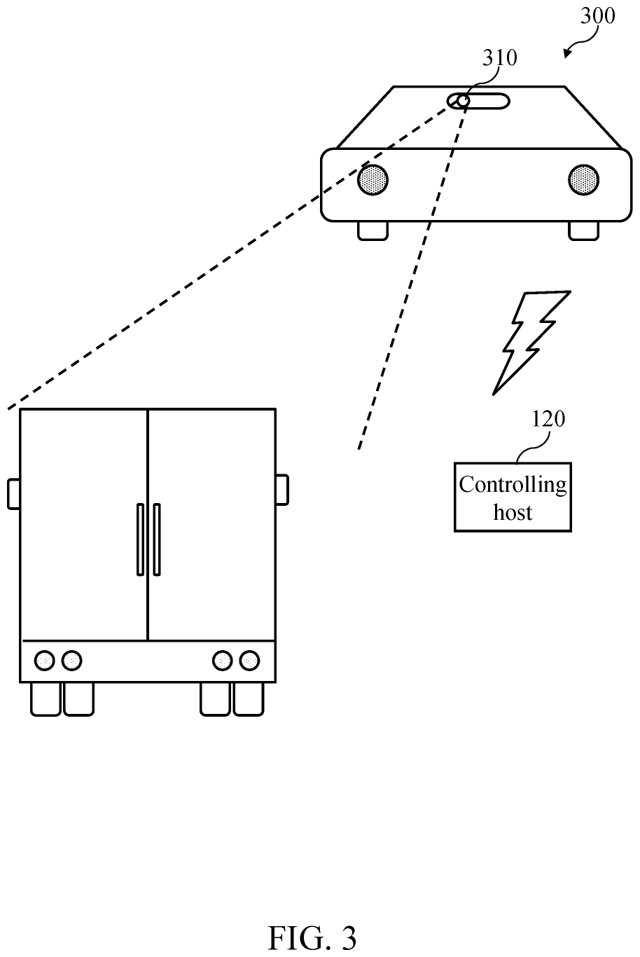

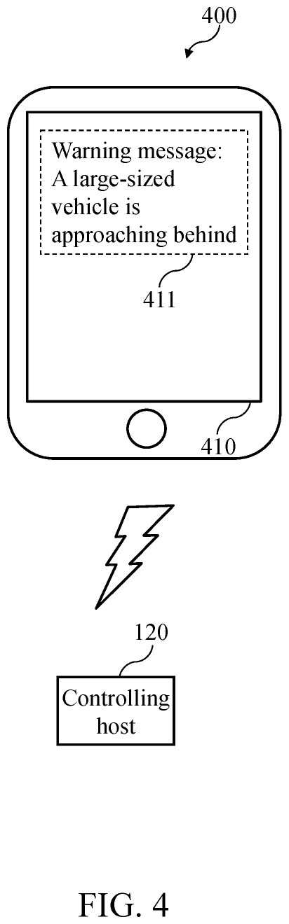

The embodiment of the present invention will be described in the following paragraphs with reference to FIGS. 3 and 4. Please refer to FIG. 3, which is a schematic diagram of application of shooting the rear video to perform controlling and warning operations during vehicle traveling, according to the present invention. In actual implementation, the camera 310 is disposed on the rear of the vehicle body 300, and when the camera 310 is enabled, the camera 310 continuously shoots video to generate and transmit the rear video to the controlling host 120. After receiving the rear video from the camera 310 through the network, the controlling host 120 can perform the image identifying process on the received rear video to identify the vehicle object in the rear video based on the features of the vehicle, and calculate the separation distance between the vehicle object and the vehicle body 300. The controlling host 120 uses the vehicle object as input data and inputs the vehicle object into the preset large-sized vehicle recognition model, so as to use the neural network to recognize whether the vehicle object is the large-sized vehicle. For example, when the large-sized vehicle recognition model outputs a Boolean value of 1, it indicates that the vehicle object is recognized as the large-sized vehicle; in contrast, when the large-sized vehicle recognition model outputs a Boolean of 0, it indicates that the vehicle object is not recognized as the large-sized vehicle. Next, after the separation distance is calculated and the vehicle object is recognized, when the separation distance is greater than the safe distance and the vehicle object is recognized as the large-sized vehicle, the controlling host 120 generates the first control signal to trigger the loudspeaker device, such as a speaker of a smartphone, a wireless headset, or a vehicle speaker, to broadcast the warning sound for prompting the driver that a large-sized vehicle is approaching; on the other hand, when the separation distance is lower than the safe distance and the vehicle object is recognized as the large-sized vehicle, the controlling host 120 generates the second control signal to trigger the speaker disposed on the vehicle body 300, so as to warn the driver of the vehicle body 300 and the driver of the large-sized vehicle at the same time. It is to particularly noted that when the second control signal is generated and the vehicle object is not located in the area behind the vehicle body 300, the controlling host 120 can drive the brake controller disposed in the vehicle body 300 to immediately reduce the speed of the vehicle body 300, to allow the large-sized vehicle to pass first; even when driving the brake controller, the controlling host 120 can also drive the steering controller disposed on the vehicle body 300 to move the vehicle body 300 away from the vehicle object until the separation distance is greater than the safe distance.

As shown in FIG. 4, which is a schematic diagram of application of transmitting the first control signal and the second control signal to the mobile device fix warning, according to the present invention. In actual implementation, when the controlling host 120 generates the first control signal and the second control signal, the controlling host 120 can transmit the first control signal and the second control signal to the mobile device 400, so that the mobile device 400 can immediately warn the driver of the vehicle body 300 by using at least one of manners of outputting text, vibrating and making sound, based on the first control signal and the second control signal. For example, when the mobile device 400 receives the first control signal, the mobile device 400 can display a warning message 411 on the displayer 410, vibrate or make sound, so as to warm the driver. It is particularly noted that, in the manner of making sound, the sound can be implemented by an audio file pre-stored in the mobile device 400, or the text to speech technology for converting the warning message 411 into speech to broadcast when the warning message 411 is displayed.

According to the above-mentioned contents, the difference between the present invention and the conventional technology is that, in the present invention, the camera disposed on the rear of the vehicle body can generate and transmit the rear video to the controlling host, and the controlling host identifies the vehicle object in the rear video and calculates the separation distance between the vehicle object and the vehicle body, and the vehicle object is inputted into the large-sized vehicle recognition model which is built based on artificial intelligence neural network and trained completely, to recognize whether the vehicle object is the large-sized vehicle, and when the vehicle object is recognized as the large-sized vehicle and the separation distance reaches to the safe distance, the warning signal is generated. Therefore, the technical solution of the present invention can solve the conventional technology problem and achieve the technical effect of improving warning immediacy for the approaching large-sized vehicle.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A controlling and warning system based on traffic conditions feedback, comprising:
a camera disposed on a rear of a vehicle body, wherein when the camera is enabled, the camera continuously shoots video to generate and transmit a rear video; and
a controlling host connected to the camera through network, and configured to receive the rear video, wherein the controlling host comprises:
a storage module configured to pre-store a large-sized vehicle recognition model which is built based on neural network and trained completely;
an identifying module configured to perform image identification process on the received rear video, to identify at least one vehicle object in the rear video and calculate a separation distance between the vehicle object and the vehicle body; and
a warning module connected to the identifying module and the storage module, and configured to input the vehicle object into the large-sized vehicle recognition model, and when the large-sized vehicle recognition model recognizes the vehicle object as a large-sized vehicle and the separation distance reaches to a safe distance, the warning module generates a warning signal.

2. The controlling and warning system based on traffic conditions feedback according to claim 1, wherein when the warning signal is generated, the controlling host outputs a warning message and calculates a difference value between the separation distance and the safe distance, when the difference value is equal to a first threshold value, the controlling host generates a first control signal to trigger a loudspeaker device to make a warning sound, and when the difference value is equal to a second threshold value, the controlling host generates a second control signal to trigger a speaker disposed on the vehicle body.

3. The controlling and warning system based on traffic conditions feedback according to claim 2, wherein the controlling host transmits the first control signal and the second control signal to a mobile device, and the mobile device immediately warns by using at least one of manners of outputting text, vibrating and making sound based on the first control signal and the second control signal.

4. The controlling and warning system based on traffic conditions feedback according to claim 2, wherein when the second control signal is generated and the vehicle object is not located an area behind the vehicle body, the controlling host drives a brake controller disposed in the vehicle body, to immediately reduce a speed of the vehicle body.

5. The controlling and warning system based on traffic conditions feedback according to claim 2, wherein when the second control signal is generated, the controlling host triggers an auxiliary brake light disposed on the vehicle body, and makes the auxiliary brake light keep on until the separation distance is greater than the safe distance.

6. A controlling and warning method based on traffic conditions feedback, comprising:
providing a controlling host, and a camera disposed on a rear of a vehicle body, wherein the camera is connected to the controlling host through network, and the controlling host pre-stores a large-sized vehicle recognition model which is built based on neural network and trained completely;
when the camera is enabled, using the camera continuously shoot environment behind the vehicle body, so as to generate and transmit a rear video to the controlling host;
using the controlling host to perform image identification process on the rear video, to identify at least one vehicle object in the rear video and calculate a separation distance between the vehicle object and the vehicle body; and
in the controlling host, inputting the vehicle object into the large-sized vehicle recognition model, and generating a warning signal when the large-sized vehicle recognition model recognizes the vehicle object as a large-sized vehicle and the separation distance reaches to a safe distance.

7. The controlling and warning method based on traffic conditions feedback according to claim 6, further comprising:
when the warning signal is generated, outputting a warning message and calculating a difference value between the separation distance and the safe distance;
generating a first control signal to trigger a loudspeaker device to make a warning sound when the difference value reaches to a first threshold value; and
generating a second control signal to trigger a speaker disposed on the vehicle body when the difference value reaches to a second threshold value.

8. The controlling and warning method based on traffic conditions feedback according to claim 7, further comprising:
using the controlling host to transmit the first control signal and the second control signal to a mobile device, so that the mobile device immediately warns by using at least one of manners of outputting text, vibrating and making sound based on the first control signal and the second control signal.

9. The controlling and warning method based on traffic conditions feedback according to claim 7, further comprising:
when the second control signal is generated and the vehicle object is not located an area behind the vehicle body, using the controlling host to drive a brake controller disposed in the vehicle body to immediately reduce a speed of the vehicle body.

10. The controlling and warning method based on traffic conditions feedback according to claim 7, further comprising:
when the second control signal is generated, using the controlling host to trigger an auxiliary brake light disposed on the vehicle body and make the auxiliary brake light keep on until the separation distance is greater than the safe distance.
